(19) United States
(12) Patent Application Publication
(10) Pub. No.: US 2018/0363794 A1
(43) Pub. Date: Dec. 20, 2018

(54) VARIABLE GEOMETRY LIFT VALVE FOR RECIPROCATING COMPRESSORS

(71) Applicant: NUOVO PIGNONE TECNOLOGIE S.r.l., Florence (IT)

(72) Inventor: Leonardo GALEOTTI, Florence (IT)

(21) Appl. No.: 15/980,156

(22) Filed: May 15, 2018

(30) Foreign Application Priority Data
Jun. 15, 2017 (IT) 102017000066770

(51) Int. Cl. F16K 17/06; F04B 39/10; F16K 17/04

(52) U.S. Cl. CPC F16K 17/06; F16K 17/044; F16K 17/0413; F04B 39/1013

(57) ABSTRACT

A valve for reciprocating compressors having a valve seat provided with first gas flow passages extending across, a valve guard having second gas flow passages extending across and at least one movable sealing element arranged between the valve guard and the valve seat and configured to move between a closed position, in which the passage of fluid is prevented, and an open position in which the passage of fluid is allowed. The movable sealing element is resiliently biased by resilient members against the valve seat to close the first gas flow passages and the valve seat and the valve guard are relatively movable to define a variable gap or lift for the sealing element.

### BACKGROUND

The present disclosure relates to valves, such as ring, annular or poppet valves. Some embodiments of the subject matter disclosed herein relate specifically to valves for reciprocating compressors.

Reciprocating compressors equipped with such valves can be employed in process applications including refineries, petro chemicals, fertilizers, refrigeration and air, as well as in the gas and oil industry, for gas re-injection, gas lift, pipeline gas transmission, gas storage and fuel gas bursting.

Valves are typically arranged on both the suction side as well as the discharge side of reciprocating compressors to automatically open and close the suction port and discharge port of the compressor under the control of the pressure inside the compressor cylinder.

An exemplary embodiment of a ring valve of the prior art is illustrated in FIG. 1. The valve 1 comprises a valve seat 2 and a valve guard 3. The valve seat is provided with circumferentially arranged gas flow passages 4 extending through the valve seat 2. The valve guard 3 is in turn provided with gas flow passages 5. A central screw 6 connects the valve seat 2 and the valve guard 3 to one another leaving a space 7 there between. A plurality of concentrically arranged sealing rings 8 are provided between the valve seat 2 and the guard valve 3. Each sealing ring 8 is arranged along a set of corresponding annularly arranged gas flow passages 4 of the valve seat 2. A plurality of compression springs 9 is provided for each sealing ring 8 to bias the sealing ring in a closed position, wherein the sealing ring 8 closes the respective set of gas passages 4 by sealingly contacting corresponding sealing surfaces of the gas flow passages 4. The compression springs 9 are housed in respective spring pockets 10 provided in the valve guard 3. Differential pressure across the valve 1 causes automatic opening and closing of the valve.

The resilient force of the springs 9 depends on the elastic coefficient of the springs and the displacements according to the well-known Hook law. That means that such force depends on the distance between the valve seat and the valve guard, i.e. on the gap between these components. In fact, if the gap, also called lift in the present disclosure, between the seat and the guard is increased, it is correspondingly decreased the compression of the spring and thus the biasing force. If the gap is decreased, the compression, and thus the force, is increased.

This means that the lift of the valve is a design parameter that should be properly calculated and designed for each operating condition of the valve. It is, however, rather uncommon that a single condition exists during an entire operative life of a reciprocating compressor. Normal usage generally involves multiple working conditions. This inevitably brings the lift value to be designed with a “best-fit” solution to accommodate multiple conditions with the result that none of such conditions is optimized. This poses the following additional problems:

Possible fluttering with low molecular weight gases or in particular conditions.

Energy wasted in each working condition due to a non-optimized lift design.

In case of nitrogen run, customer needs a dedicated set of valves.

Possible higher temperatures on discharge gas.

It would be thus desirable to design and provide a valve which overcomes the aforementioned drawbacks.

### BRIEF DESCRIPTION

According to first exemplary embodiments, a valve for reciprocating compressors is described. The valve is provided with a valve seat having first gas flow passages, a valve guard having second gas flow passages and at least one movable sealing element arranged between the valve guard and the valve seat. The sealing element is configured to move between a closed position in which the passage of fluid is prevented and an open position in which the passage of fluid is allowed, and it is biased by resilient members against the valve seat to close the first gas flow passages. The valve seat and the valve guard are relatively movable in order to define a variable gap or lift for the sealing element.

This allows modifying the lift parameter to adapt the valve for different gases, pressures and running conditions. As a consequence, discharge temperatures are sensibly decreased with high percentages of energy saving (up to 25%) on high molecular weight gases with increased operability for reciprocating compressors.

In the simplest solution, an elastic element is interposed in such gap or lift. An actuator provides the correct relative position between the valve seat and the valve guard in order to vary the lift either manually or automatically. This variation in position leads to obtain valves optimized for each running condition with following positive effects:
avoiding fluttering effects,
keeping pulsations under control (with the possibility to have smaller pulsation vessels),
no need of a dedicated set of valves for Nitrogen run,
high energy savings,
increased valve's operative life,
discharge gas temperatures sensibly decreased.

This upgrade solution can be applied on both discharge and suction valves at the same time and with the unloaders thus leading also to a high competitive solution and is applicable also in presence of normal pneumatic unloaders on suction valves.

According to second exemplary embodiments, there is a reciprocating compressor comprising a valve according to embodiments herein.

According to third exemplary embodiments, there is a method for operating a reciprocating compressor in a specific working condition by using a valve according to embodiments herein.

### BRIEF DESCRIPTION OF THE DRAWINGS

The following description of exemplary embodiments will become more apparent when considered in conjunction with the accompanying drawings wherein:

FIG. 1 illustrates a cross section according to a longitudinal plane of an automatic ring valve of the current state of the art;

FIG. 2 illustrates longitudinal cross section of the head of a current state of the art reciprocating compressor where valves according to exemplary embodiments herein can be used;

FIG. 3 illustrates a cross section according to a longitudinal plane of an automatic ring valve with elastic elements (Belleville washers) between valve seat and valve guard according to embodiments herein;

FIG. 4 illustrates the same valve of FIG. 3 having helical springs as elastic members between the valve seat and the valve guard;

FIGS. 5 and 6 illustrate a cross section of a valve actuated through a rotating shaft. In this solution, the shaft moves the valve guard with its rotating movement. This leads to increase the lift dimension between valve seat and valve guard;

FIGS. 7 and 8 illustrate the same valves of FIGS. 5 and 6 actuated through a translational shaft;

FIGS. 9 and 10 illustrate an embodiment of a valve having an intermediate plate between the valve seat and the valve guard. The plate can be moved vertically and it acts like a stop for the rings, modifying the lift dimension; and

FIGS. 11, 12, 13, 14, 15, 16, 17 and 18 (hereinafter FIGS. 11-18) illustrate further exemplary embodiments of FIGS. 3 and 4 mainly differing for the type of actuator used for varying the lift between the valve seat and the valve guard.

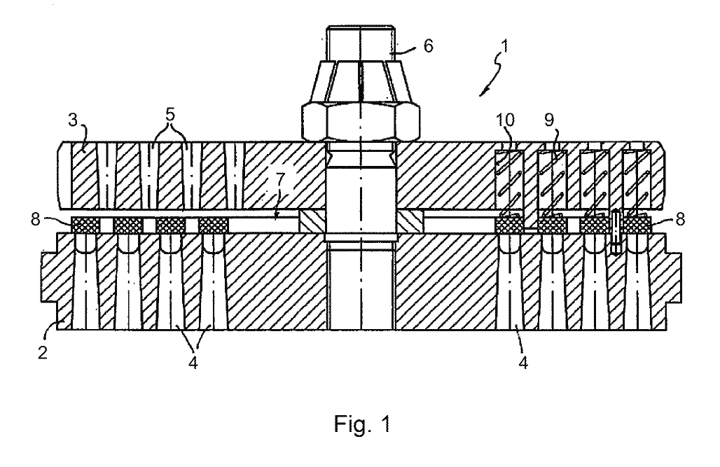

### DETAILED DESCRIPTION

The following description of exemplary embodiments refer to the accompanying drawings. The same reference numbers in different drawings identify the same or similar elements. The following detailed description does not limit the invention. Instead, the scope of the invention is defined by the appended claims.

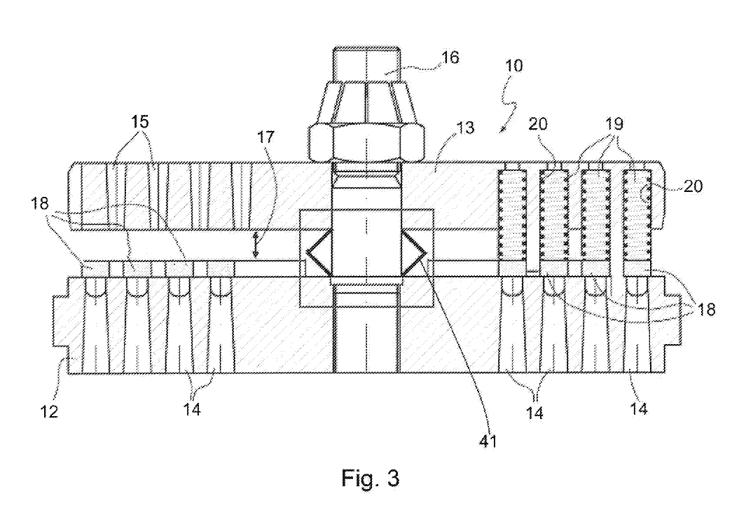

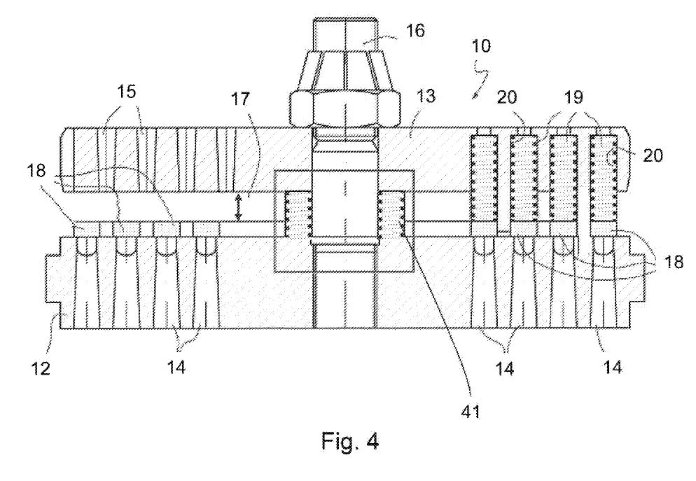

An exemplary embodiment of an automatic ring valve is illustrated in FIGS. 3 and 4. The automatic ring valve 10 comprises a valve seat 12 and a valve guard 13. The valve seat is provided with circumferentially arranged gas flow passages 14 extending through the valve seat 12. The valve guard 13 is in turn provided with gas flow passages 15. A central screw 16 connects the valve seat 12 and the valve guard 13 to one another with interposition of one or more elastic elements 41 like Belleville washers (FIG. 3) or springs (FIG. 4) leaving a variable space or lift 17 there between.

At least one shutter ring 18 is placed between the valve seat 12 and the valve guard 13. The shutter ring 18 is arranged along a corresponding gas flow passage 14 of the valve seat 12. When a plurality of annularly arranged gas flow passages 14 of the valve seat 12 are present, a plurality of concentrically arranged shutter rings 18 is placed between the valve seat 12 and the valve guard 13. A plurality of contrasting members for contrasting an opening movement of the shutter rings 18 are provided; as an example, these members consist of a plurality of resilient members, as compression springs 19, for each shutter ring 18 for biasing the shutter ring 18 in a closed position, wherein the shutter ring 18 closes the respective set of gas flow passages 14 by sealingly contacting corresponding sealing surfaces of the gas flow passages 14. The compression springs 19 are housed in respective spring pockets 20 provided in the valve guard 13.

Differential pressure across the valve 10 causes automatic opening and closing of the valve.

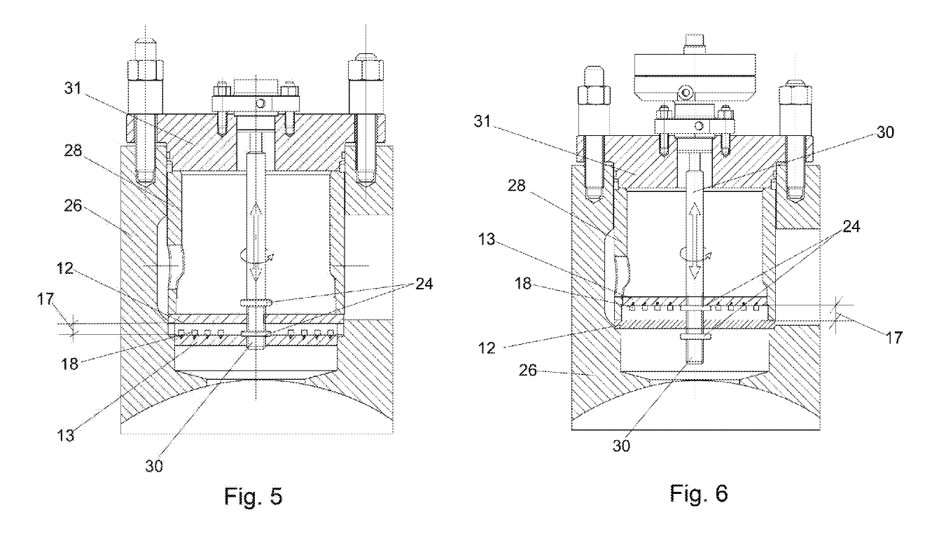

A further embodiment is shown in FIGS. 5 and 6. Here the valve is illustrated in mounting position with its cage 28 within a cylinder 26, particularly to act as a suction valve (on the left) and a discharge valve (on the right) of a reciprocating compressor. The difference between the two configurations is represented by the exchange in position of the valve seat 12 and the valve guard 13, also called in the present disclosure counter seat. The seat 12 is fixed to the cylinder 26, while the guard 13 is fixed to the shaft 30. The displacement of the shaft 30 allows for increasing or decreasing the lift 17 between valve seat 12 and valve guard 13. Stroke stops 24 are present to limit the excursion of the shaft 30 and thus set a limit range for the lift 17.

In the configuration of FIGS. 5 and 6, the seat 12 has a threaded hole coupled to corresponding threads of the shaft 30 acting as a worm screw to convert rotation of the shaft in a translation movement.

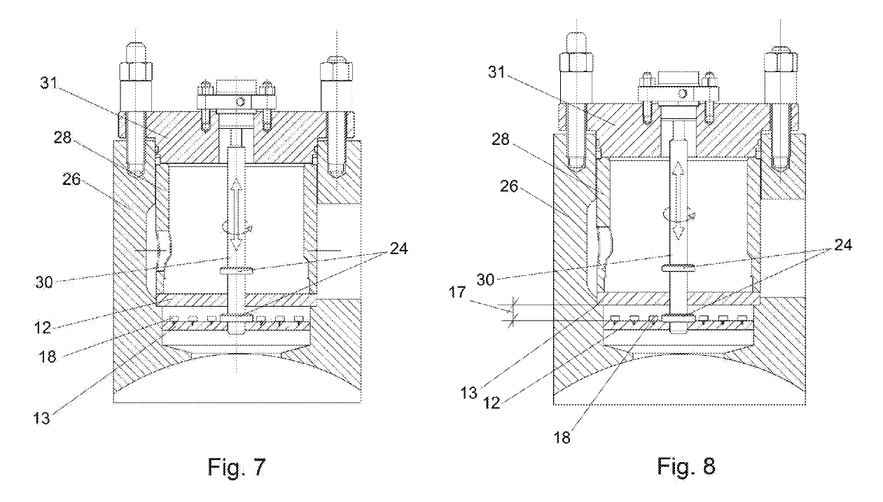

In the configuration of FIGS. 7 and 8, the shaft 30 is directly actuated to translate without any cinematic conversion. In any case the result is a variable gap 17 between valve seat 12 and valve guard 13 that can be finely tuned controlling an actuator.

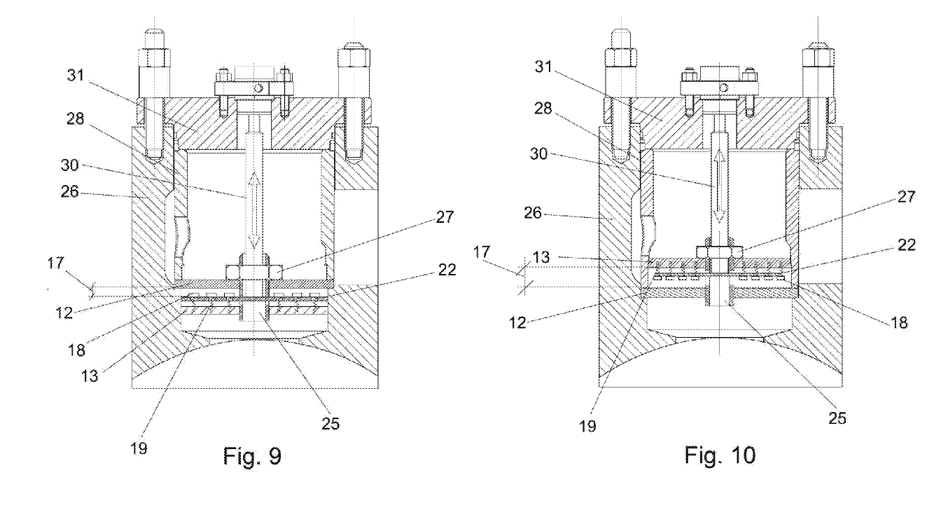

FIGS. 9 and 10 show another embodiment. Here a plate 22 between valve seat 12 and valve guard 13 is introduced. The valve assumes the configuration as disclosed in WO 2013/087615 to be considered herein included by reference.

According to the subject matter disclosed herein, the plate 22 is removable such that it can be replaced, e.g. if the seat plate breaks or is worn. A plurality of contrasting members for contrasting an opening movement of the plate and thus of the sealing rings 18 are provided; as an example, these members consist of a plurality of resilient members, as compression springs 19.

In this configuration, the variable lift or gap 17 of the valve is formed between the plate 22 and the seat 12 with possible interposition of one or more elastic elements 41 like Belleville washers or springs.

The valve seat 12 is fixed to the cylinder 26 of the valve while the plate 22 is fixed to the shaft 30. The guard 13 is fixed and only the plate 22 can translate to vary the lift 17. Stroke stops 24 may be provided, for example, in the form of protrusions of the bolt 25 fixing the guard 13.

As in the configuration of FIGS. 5, 6, 7 and 8, translation of the shaft 30 may be caused by its rotation due to a worm screw gear or to the direct action of a linear actuator or both.

More in general any type of coupling can be used as long as it is able to vary the distance between the seat and the counter seat or between the seat/counter seat and an element located between the seat and the counter seat like a plate. Not limiting examples include oil/air, single or multi piston actuators, electromagnetic, piezoelectric actuators, stepper motors or the like.

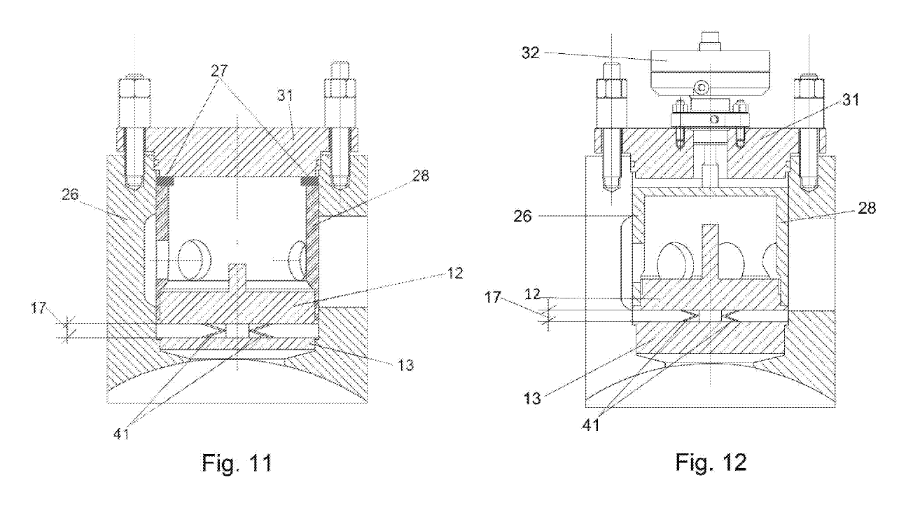

In the embodiments according to FIGS. 11-18, the seat 12 is fixed to the valve cage 28 and the counter seat 13 is fixed to the cylinder 26 or viceversa. The gap 17 between the seat 12 and counter seat 13 can be trimmed by acting on the cage 28. The simplest way is by introducing shims 27 of variable size between cage 28 and cover 31 as shown in FIG. 11. More sophisticated solutions require the presence of an actuator 32 pushing on the cage 28 against the action of one or more contrasting members 41 located in the gap 17 between the seat 12 and the counter seat 13.

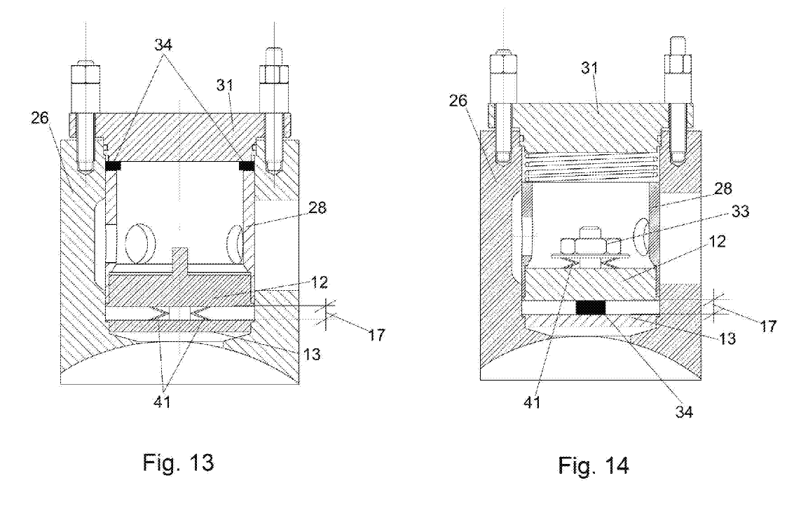

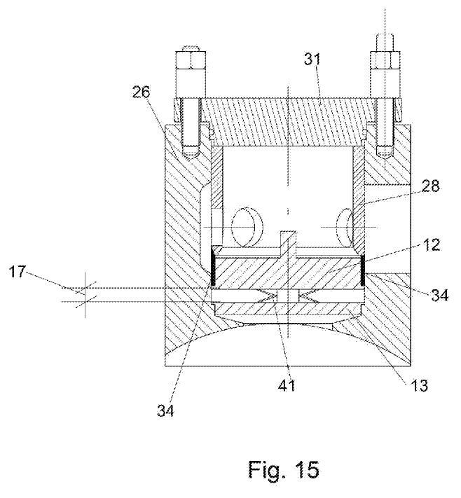

Also in this case different type of actuators can be used for the purpose. FIG. 12 shows a configuration with an oil/air actuator 32. In FIGS. 13-15, a piezoelectric actuator 34 inside the gas chamber is used. This can be placed between the cage 28 and the cover 31 (FIG. 13), between the seat 12 and counter seat 13 with elastic elements 41 contrasting the movement located between the seat 12 or the counter seat 13 and a bolt 33 securing the seat 12 or counter seat 13 with the cylinder (FIG. 14) or between the cage 28 and the seat 12 or the counter seat 13 (FIG. 15).

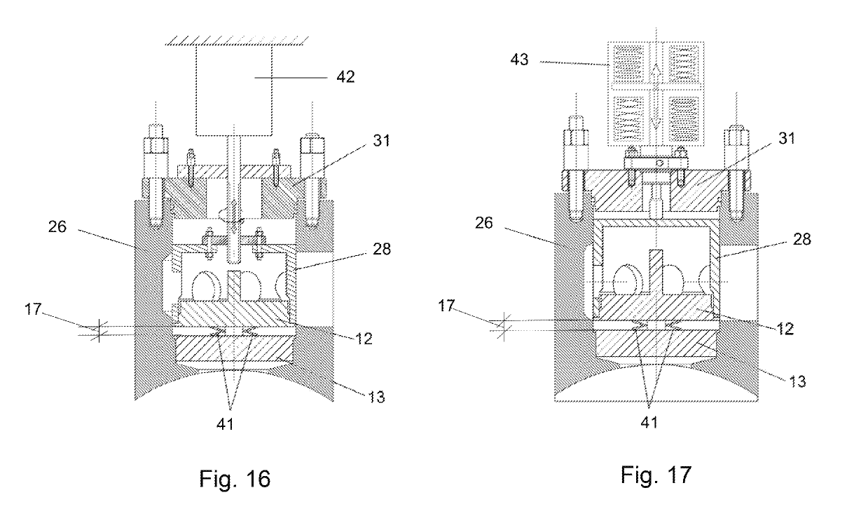

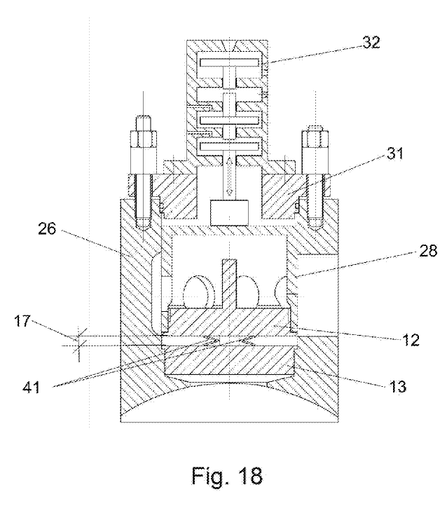

In the embodiment of FIG. 16 a stepper motor 42 acting on a screwjack linked to the valve cage is used. In FIG. 17 an electromagnetic actuator 43 is provided while in FIG. 18 a multi-piston configuration is shown.

Embodiments have been mainly illustrated with reference to ring valves, but the teachings herein can be easily extended also to other type of valves such as poppet valves as those disclosed, for example, in U.S. Pat. No. 9,297,373.

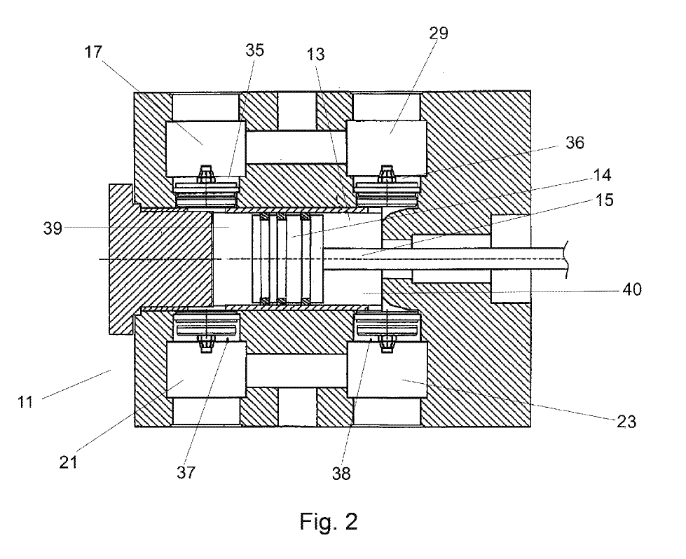

FIG. 2 illustrates the head 11 of a reciprocating compressor using four automatic ring valves 1 according to embodiments herein. The valves are arranged on the suction ports and discharge ports of the compressor designated 35, 36, 37, 38.

More in detail, the compressor head 11 defines a compressor cylinder 13 wherein a piston 14 is reciprocatingly movable. A rod 15 of the piston 14 is connected to a crank (not shown), which reciprocatingly moves the piston 14 according to double arrow f14. The piston 14 divides the cylinder 13 into two separate compression chambers 39, 40.

The compressor head 11 is provided with a first suction port 17 in fluid communication with the first compression chamber 39 through a first automatic ring valve 35. A second suction port 29 is in fluid communication with the second compression chamber 40 through a second automatic ring valve 36. A first discharge port 21 is in fluid communication with the first compression chamber 39 through a third automatic ring valve 37 and a second discharge port 23 is in fluid communication with the second compression chamber 40 through a fourth automatic ring valve 38.

The reciprocating motion of the piston 14 causes selectively suction of the gas in the first compression chamber 39 and discharge of compressed gas from the second compression chamber 40 and vice versa. The automatic ring valves 35, 36, 37 and 38 selectively open when the pressure in the first gas flow passages 4 exceeds the resilient force of the springs 19.

Embodiments of the invention may reside in the clauses as set forth below or any combination thereof:

A compressor further comprising a control unit configured to drive the actuator of the valves to trim the lift according to specific working condition.

A method for operating a reciprocating compressor in a specific working condition, the compressor comprising a cylinder, a piston sliding in said cylinder, a suction duct with a suction valve and a discharge duct with a discharge valve, each valve comprising a valve seat and a valve guard relatively movable (with variable lift solution), at least one shutter, at least one biasing member configured to bias the shutter towards a closing position, the method comprising:

varying the mutual position of the valve seat and the valve guard to set a gap between the valve and the seat optimized for the working condition of the compressor;

reciprocatingly moving the piston in the cylinder to suck a gas in the cylinder at a suction pressure and discharge the gas from the cylinder at a discharge pressure;

selectively opening and closing the suction valve and the discharge valve by differential pressure across the valves.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

section:

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. Valve for reciprocating compressors, the valve comprising:
a valve seat with first gas flow passages extending through the valve seat;
a valve guard having second gas flow passages extending through the valve guard;
at least one shutter ring arranged between the valve guard and the valve seat, the shutter ring being configured to move between a closed position in which the passage of fluid is prevented and an open position in which the passage of fluid is allowed,
wherein the at least one shutter ring is resiliently biased by resilient members against the valve seat to close the first gas flow passages,
wherein the valve seat and the valve guard are relatively movable to define a variable gap or lift for the sealing element.

2. Valve according to claim 1, wherein one or more contrasting members are provided, such as springs, Belleville washers or the like, such contrasting members being located in the gap between the seat and the guard or between the seat or the guard and a stationary part of the valve.

3. Valve according to claim 1, further comprising an actuator to adjust the relative position of the valve seat and the valve guard.

4. Valve according to claim 3, wherein the actuator acts on a translating element, the valve guard being coupled to such element to translate to/from the valve seat.

5. Valve according to claim 4, further comprising stop members to limit the excursion of the translating element and thus set a range of values for the lift.

6. Valve according to claim 4, wherein the translating element comprises a rotating shaft, the seat having a threaded hole coupled to corresponding threads of the shaft to act as a worm screw to convert rotation of the shaft in a translation movement.

7. Valve according to claim 1, wherein the seat or the guard is coupled with a valve cage, the movement of the cage causing the displacement of the valve seat with respect to the valve guard or vice versa.

8. Valve according to claim 7, wherein a calibration stop member of a set of stop members is interposed between the cage and a cover or a static part of the valve to shim the position of the cage with respect to the seat or the guard.

9. Valve according to claim 7, wherein an actuator is provided to act on the cage to relatively displace the valve seat with respect to the valve guard.

10. Valve according to claim 1, wherein the actuator is selected from the group comprising: oil/air, single or multi piston, electromagnetic, piezoelectric actuators, stepper motors.

11. Valve according to claim 1, further comprising a plate interposed between the valve seat and the valve guard, wherein the at least one shutter ring is resiliently biased by resilient members against the removable plate to close the first gas flow passages, the variable gap or lift being formed between the plate and the valve seat with interposition of one or more elastic elements such as Belleville washers, springs or the like.

12. A reciprocating compressor comprising a valve according to claim 1.

13. A reciprocating compressor according to claim 12 comprising a compressor head defining a compressor cylinder wherein a piston is reciprocatingly movable, wherein the piston divides the cylinder into two separate compression chambers, the compressor head being provided with:
a first suction port in fluid communication with the first compression chamber through a first automatic ring valve;
a second suction port in fluid communication with the second compression chamber through a second automatic ring valve;
a first discharge port in fluid communication with the first compression chamber through a third automatic ring valve; and
a second discharge port in fluid communication with the second compression chamber through a fourth automatic ring valve,
wherein the reciprocating motion of the piston causes selectively suction of the gas in the first compression chamber and discharge of compressed gas from the second compression chamber and vice versa, the automatic ring valves being configured to selectively open when the pressure in the first gas flow passages exceeds the resilient force of the springs, wherein at least one of the automatic ring valves is a valve.

14. Compressor according to claim 12, further comprising a control unit configured to drive the actuator of the valves to trim the lift according to specific working condition.

15. Method for operating a reciprocating compressor in a specific working condition, the compressor comprising a cylinder, a piston sliding in the cylinder, a suction duct with a suction valve and a discharge duct with a discharge valve, each valve comprising a valve seat and a valve guard relatively movable, at least one shutter, at least one biasing member configured to bias the shutter towards a closing position, the method comprising:
varying the mutual position of the valve seat and the valve guard to set a gap between the valve and the seat optimized for the working condition of the compressor;
reciprocatingly moving the piston in the cylinder to suck a gas in the cylinder at a suction pressure and discharge the gas from the cylinder at a discharge pressure;
selectively opening and closing the suction valve and the discharge valve by differential pressure across the valves.
